(19) United States
(12) Patent Application Publication
(10) Pub. No.: US 2011/0218796 A1
(43) Pub. Date: Sep. 8, 2011

(54) TRANSLITERATION USING INDICATOR AND HYBRID GENERATIVE FEATURES

(75) Inventors: Hisami Suzuki, Redmond, WA (US); Colin Andrew Cherry, Ottawa (CA)

(73) Assignee: Microsoft Corporation, Redmond, WA (US)

(21) Appl. No.: 12/717,968

(22) Filed: Mar. 5, 2010

(51) Int. Cl. G06F 17/28

(52) U.S. Cl. 704/2

(57) ABSTRACT

Described is a transliteration engine/substring decoder that back-transliterates an input string from a source language into an output string in a target language. The transliteration engine may be based upon discriminately weighted indicator features and/or generative models in which the decoder's discriminative parameters are learned. The training data may be based on source-target pairs, which may be transformed into derivations. Features extracted from these derivations include indicator features and hybrid generative model features.

### BACKGROUND

Transliteration occurs when a word is borrowed by a language that has a different character set, and the word is transcribed into the new character set in such a way as to maintain approximate phonetic correspondence. For example, the English language word ‘hip-hop’ has been adopted by into the Japanese language ( [symbol] ) and pronounced as “hippuhoppu” when transliterated into Japanese.

In natural language processing, it is desirable to be able to convert one language to another by way of machine translation; it is also desirable to convert a word borrowed into a foreign language by transliteration back into its original language, referred to as back-transliteration. In back-transliteration, recovery is generally possible because of pronunciation similarities. For example, the English-language string ‘hip-hop’ may be recovered because hippuhoppu is pronounced similarly to hip-hop, which is a term that appears in appropriate English-language dictionaries.

Technology to back-transliterate words can be useful in cases where a translation is not readily available from other sources. For example, when automatically translating from a source language into a target language, if the system encounters a proper name in the source text that has not been seen in its translation lexicons or training data, it can still fall back on the source word's transliteration to create useful output in the target language.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a transliteration engine/substring decoder processes (back-transliterates) an input string in one (source) language into an output string in another (target) language, in which the transliteration engine is based upon a discriminately trained combination of generative models. In one implementation, the decoder's discriminative parameters (e.g., weights for probabilities corresponding to features) are learned via training, e.g., structured perceptron training.

The training data may be based on source-target pairs, which may be transformed into derivations. Features extracted from these derivations include indicator features and hybrid generative model features.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for training/using a transliteration engine discriminately trained using hybrid generative features.

FIG. 2 is a representation of transforming training data in the form of source language-target language pairs into derivations from which features are extracted.

FIGS. 3A-3F are representations of indicator features and generator features used in discriminative training of the transliteration engine.

FIGS. 4 and 5 are representations of structured perceptron training to learn parameters for the generative models.

FIG. 6 is a representation of how characters and substrings are aligned for use in transliteration.

FIG. 7 shows an illustrative example of a computing environment into which various aspects of the present invention may be incorporated.

### DETAILED DESCRIPTION

Various aspects of the technology described herein are generally directed towards a transliteration engine that generates entirely new strings when needed, while preferring to generate words that are in a dictionary. To this end, a transliteration engine is based upon using generative models as features in a discriminative training framework for the task of transliteration/back-transliteration. The technology may be used in machine translation, for example, to produce transliterations where a translation engine failed to produce an output in the script that is appropriate for the target language. Other applications include using the engine as a postprocessor for machine translation, as a component for computing edit distance between two strings, and/or as a spelling assistant.

It should be understood that any of the examples herein are non-limiting. Indeed, some of the examples herein are directed towards Japanese katakana to English transliteration/back-transliteration, however these are only examples, and the technology is language-independent. Other languages, particularly with other alphabets/character sets such as Arabic, Chinese, Korean, Russian and so forth may likewise significantly benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and language processing in general.

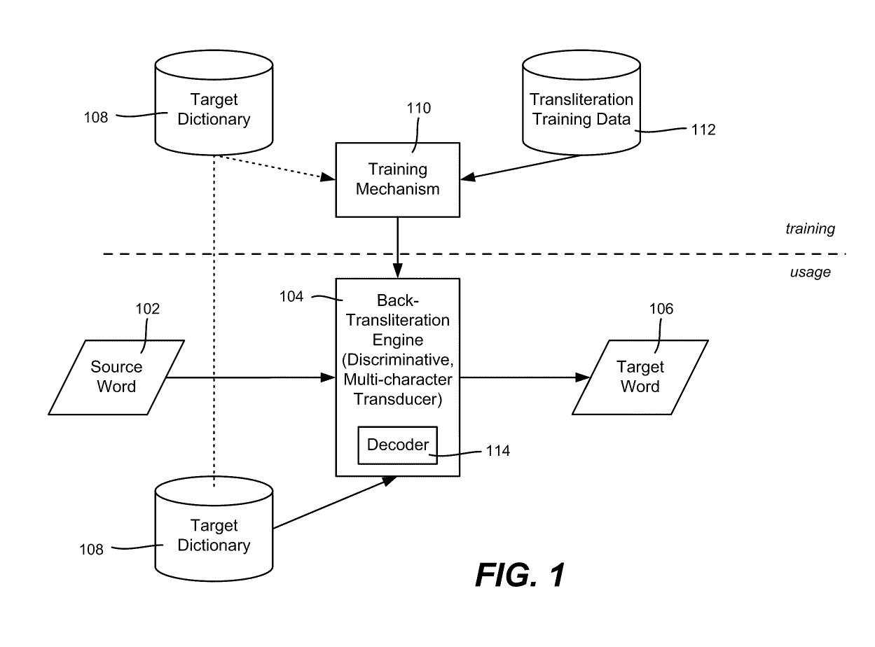

FIG. 1 shows various aspects related to the technology described herein, including a system for transduction-based transliteration, in which a source word 102 (e.g., provided by a machine translator) is transformed by a back-transliteration engine 104 into a target word 106, using a sequence of character-level operations described below. As also described below, the engine 104 is based upon a transduction process, in which the parameters of the transduction process are learned from a collection of transliteration pairs. Note that such systems do not require a list of candidates, but many incorporate a target lexicon/dictionary 108, favoring target words that occur in the lexicon. This approach is also known as transliteration generation.

Also shown in FIG. 1 is a training mechanism 110 that trains the engine 104 via discriminative training based upon transliteration training data 112, that is, features extracted from the training data. Training is described below with respect to example perceptron training, however other models trained discriminative training, e.g., maximum entropy models, MART (Multiple Additive Regression Trees) and so forth may be used.

For transliteration, the engine 104 includes (or is otherwise associated with) a discriminative substring decoder 114, which is based upon discriminative transduction. In one implementation, the decoder 114 is trained via a structured perceptron, which learns weights for the transliteration features, which are drawn from distinct classes, including indicator and hybrid generative features, as described below.

In one implementation, the decoder's discriminative parameters are learned with structured perceptron training. More particularly, let a derivation d describe a substring operation sequence that transliterates a source word into a target word. Given an input training data (corpus) of such derivations D=d₁ . . . dₙ, a vector feature function on derivations \vec{F}(d), and an initial weight vector \vec{w}, the exemplified perceptron performs two steps for each training example dᵢεD:

Decode: d̅=argmax_{dεD(src(d}_{ᵢ}₎₎(\vec{w}·\vec{F}(d))

Update: \vec{w}=\vec{w}+\vec{F}(d₁)−\vec{F}( d̅)

where D(src(d)) enumerates the possible derivations with the same source side as d. To improve generalization, in one implementation, the final feature vector is the average of the vectors found during learning. Accuracy on the development set is used to select the number of times all dᵢεD is passed through.

Given the above framework, training derivations D, feature vectors \vec{F} and a decoder are needed to carry out the argmax over all d reachable from a particular source word. Each of these components is described below.

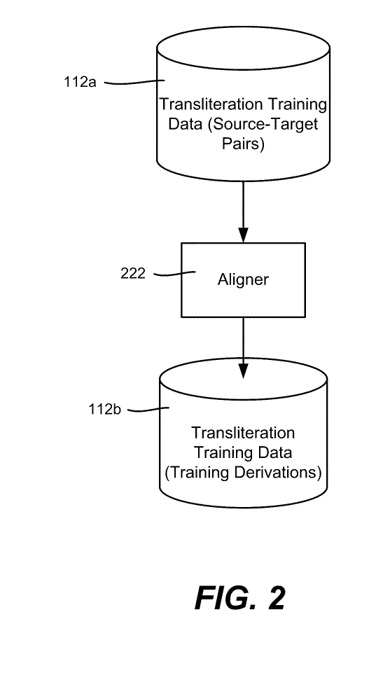

With respect to training derivations, note that the above framework describes a max-derivation decoder trained on a corpus of “gold-standard” derivations, as opposed to a max-transliteration decoder trained directly on source-target pairs, e.g., matching text found in reference materials. Building the system on the derivation level avoids issues that may occur with perceptron training with hidden derivations. However, as represented in FIG. 2, this introduces the need to transform the training source-target pairs 112a into training derivations 112b. Training derivations can be learned unsupervised from source-target pairs using character alignment techniques, as represented in FIG. 2 via the character aligner 222. One approach employs variational expectation maximization (EM) with sparse priors, along with hard length limits, to reduce the length of substrings operated upon in an attempt to learn only non-compositional transliteration units.

In one implementation, the aligner 222 produces only monotonic alignments, and does not allow either the source or target side of an operation to be empty. The same restrictions may be imposed during decoding (as described below). In this way, each alignment found by variational EM is also an unambiguous derivation. In one implementation, the training data corpus is aligned with a maximum substring length of three characters.

As described above, two distinct classes of features are used, including indicators and hybrid generative features. Indicators detect binary events in a derivation, such as the presence of a particular operation. Hybrid generative features assign a real-valued probability to a derivation, based on statistics collected from training derivations. Note that indicators are sparse and knowledge-poor, while each generative feature carries a relatively substantial amount of information. Further note that generative hybrids are often accompanied by a small number of unsparse indicators, such as operation count.

Further, generative models need large amounts of data to collect statistics, and relatively little for perceptron training, while sparse indicators require only a large perceptron training set. The process may further divide feature space according to the information needed to calculate each feature.

The feature sets may be partitioned into a number of subtypes, including emission, which indicates how accurate the operations used by this derivation are, and transition, which indicates whether the target string produced by this derivation looks like a well-formed target character sequence. Another subtype is lexicon, which indicates whether the target string contains known words from a target lexicon (dictionary 108).

Previous approaches to discriminative character transduction tend to employ only sparse indicators because sparsity is not a significant concern in character-based domains, and sparse indicators are extremely flexible. Emission indicators are centered around an operation; an indicator may exist for each operation. More source context features can be generated by conjoining an operation with source n-grams found within a fixed window of C characters to either side of the operation. These source context features have minimal computational cost, and they allow each operator to account for large, overlapping portions of the source, even when the substrings being operated upon are small. Transition indicators stand in for a character-based target language model.

Indicators are built for each possible target n-gram, for n=1 . . . K, allowing the perceptron to construct a discriminative back-off model. In one implementation, suitable values are C=3 and K=5.

Given access to a target lexicon with type frequencies, features are created that indicate the frequencies of generated target words according to coarse bins. In one implementation, five frequency bins: [<2,000], [<200], [<20], [<2], [<1] are used. To keep the model linear, these features are cumulative. For example, generating a word with frequency 126 will result in both the [<2,000] and [<200] features firing. Note that a single transliteration can potentially generate multiple target words, and doing so can have an impact on how often the lexicon features fire. Thus, another feature, which indicates the introduction of a new word, may be used. The frequency indicators allow a designer to select notable frequencies. In particular, the selected bins do not give any advantage to extremely common words, as these are generally less likely to be transliterated. Note that other features may be used, such as those in machine translation, e.g., an operation-count feature, or a character-count feature.

With respect to hybrid generative features, the three components of a traditional, generative noisy channel can be discriminatively weighted, producing:

w_{E} log P_{E}(s|t)+w_{T} log P_{T}+w_{L} log P_{L}(t)

with weights w learned by perceptron training or other discriminative training as described above. These three models align with the three feature subtypes. Thus, emission information is provided by P_{E}(s|t), which may be estimated by maximum likelihood on the operations observed in the training derivations. Further note that including source context is difficult in such a model, so to compensate, the systems using P_{E}(s|t) also use composed operations, which are constructed from operation sequences observed in the training set. This removes the length limit on substring operations.

In an implementation in which derivations built by the character aligner 222 use operations on substrings of a maximum length three, to enable perceptron training with composed operations, once P_{E}(s|t) has been estimated by counting composed operations in the initial alignments, the training examples are realigned with those composed operations to maximize P_{E}(s|t), creating new training derivations. P_{T}(t) provides transition information through a character language model, estimated on the target side of the training derivations. In one implementation, a well-known Kneser-Ney smoothed 7-gram model is used. P_{L}(t) is a unigram target word model, estimated from the same type frequencies used to build the lexicon indicators. Because of the linear model, other features may be incorporated, such as P_{E}′(t|s), target character count, and operation count.

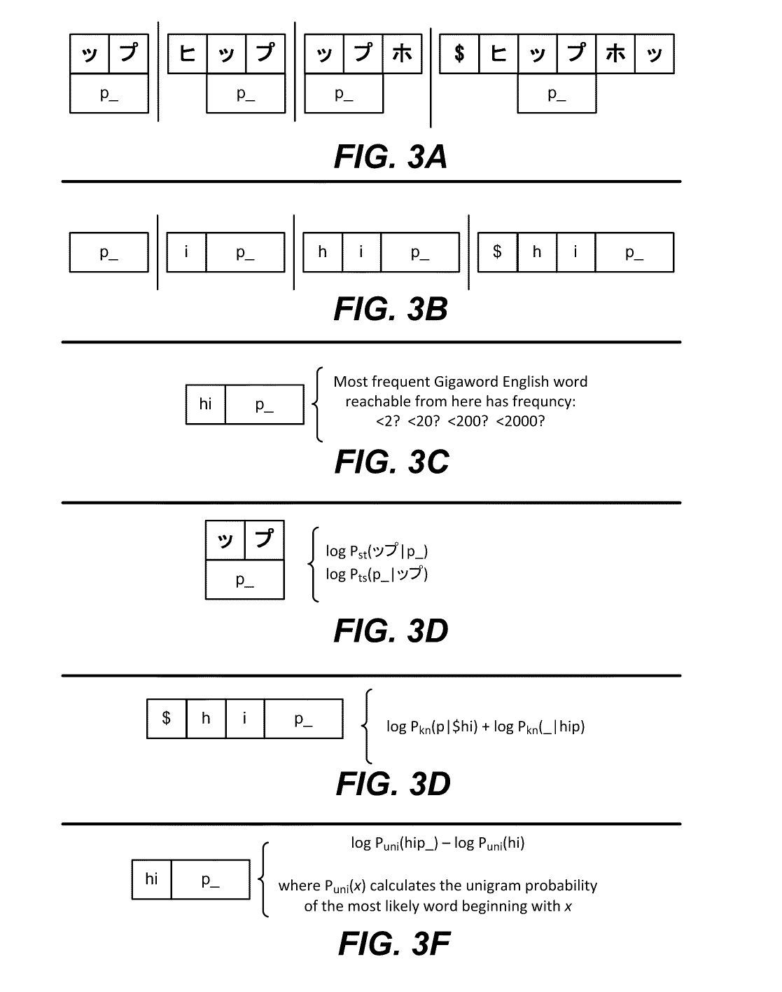

FIGS. 3A-3F summarize example indicator features and generative features/models. FIG. 3A represents channel indicators (with source context); FIG. 3B represents language model indicators; and FIG. 3C represents lexicon (dictionary) indicators. FIG. 3D represents channel models; FIG. 3E represents the language model; and FIG. 3F represents the dictionary model.

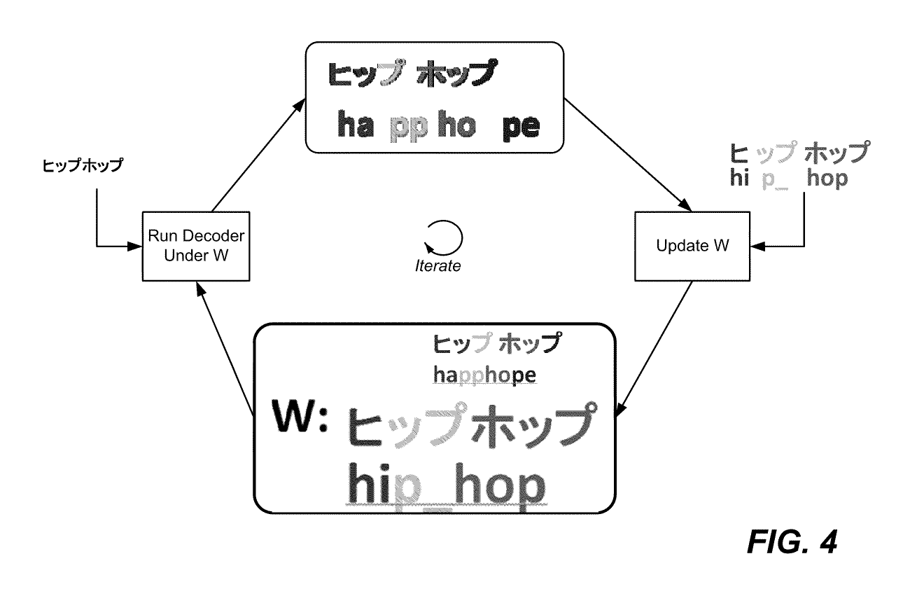

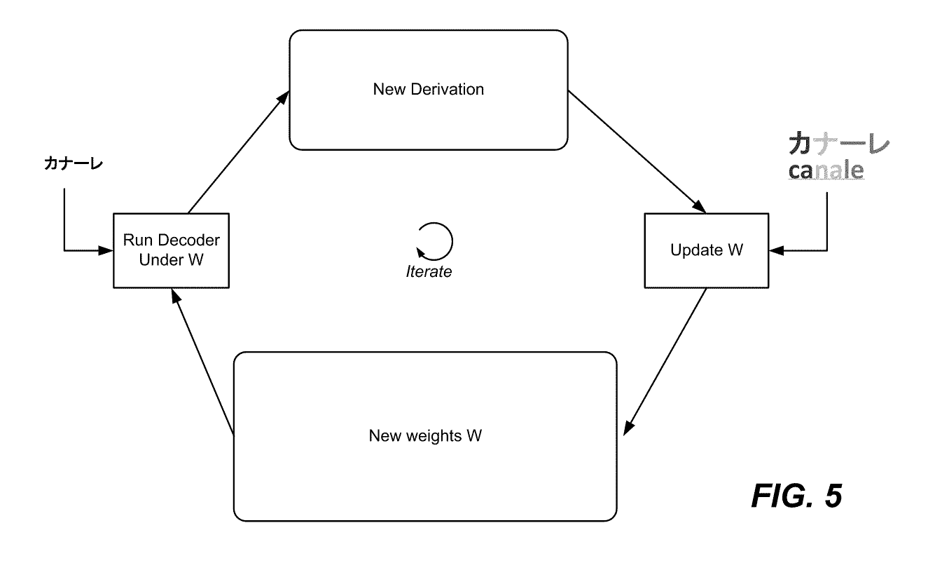

FIGS. 4 and 5 show examples of perceptron training given the corpus of derivations (s,t,d), where s represents a source word, t a target word, and d the derivation. Training defines features for the operations in derivation, such as an indicator for a Japanese character to an English-language substring. A derivation is described by a vector of features F(s,t,d). Then, given a weight on each feature, described by the vector W, the score of a derivation is the sum of its weighted features, namely Score(s,t,d)=W·F(s,t,d).

As generally represented in FIGS. 4 and 5, perceptron training occurs by iteratively predicting a target transliteration, given the source and the current weight vector, and updating the weight vector for each iteration. As described above, the final feature vector is the average of the vectors over all iterations found during learning.

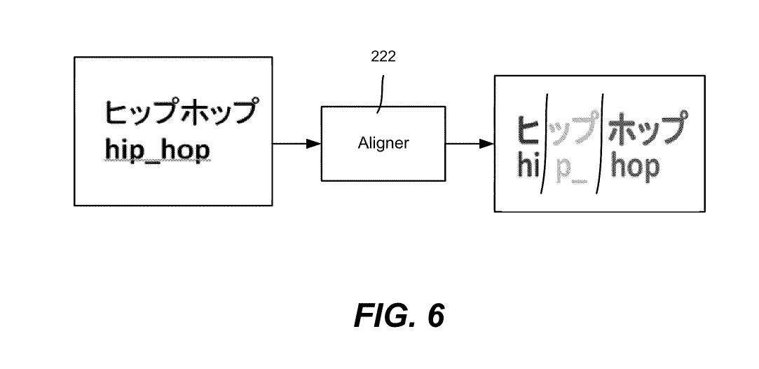

Alignment is generally represented in FIG. 6. In one implementation, alignment uses absolute limits on the number of characters in each operation, plus sparse priors, to learn meaningful units. Also, one optimization deletes the derivations having rare operations, which reduces the training data to only those with cleaner derivations.

Turning to decoding, in one implementation, a dynamic programming (DP) decoder extends the Viterbi algorithm for Hidden Markov Models (HMMs) by operating on one or more source characters (a substring) at each step. A DP block stores the best scoring solution for a particular prefix. Each block is subdivided into cells, which maintain the context needed to calculate target-side features. One implementation employs a beam, keeping only the forty highest scoring cells for each block, which speeds up inference at the expense of optimality. The beam has no significant effect on perceptron training, nor on the system's final accuracy.

Previously, target lexicons have been used primarily in finite-state transliteration, as they are easily encoded as finite-state-acceptors. It is possible to extend the DP decoder to also use a target lexicon. Encoding the lexicon as a trie, and adding the trie index to the context tracked by the DP cells, provides access to frequency estimates for words and word prefixes. This has the side-effect of creating a new cell for each target prefix; however, in the character domain, this remains computationally tractable.

### Exemplary Operating Environment

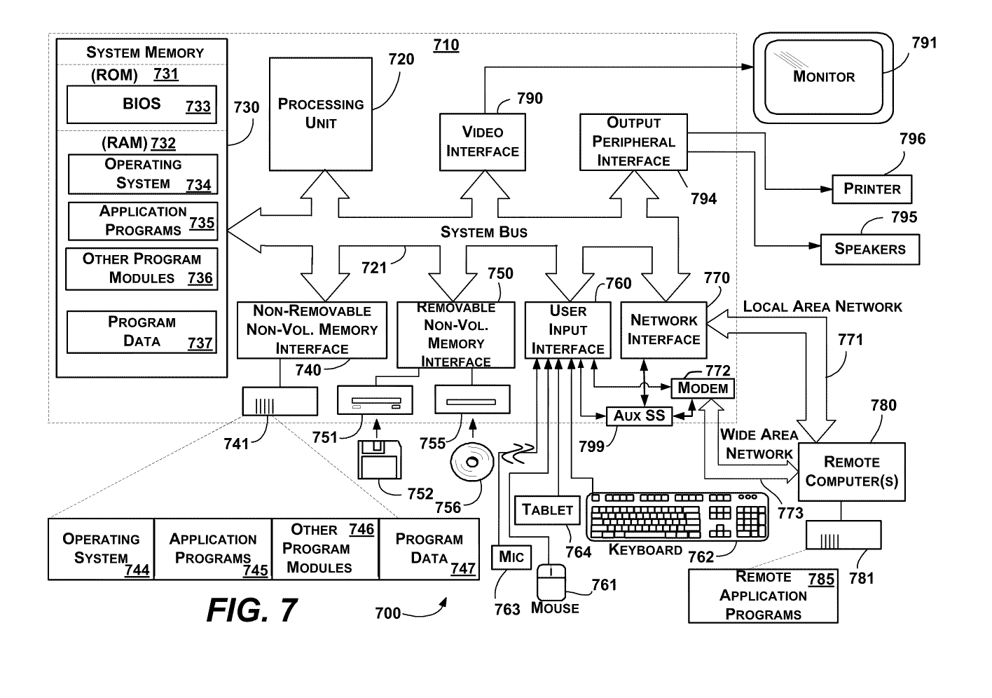

FIG. 7 illustrates an example of a suitable computing and networking environment 700 on which the examples of FIGS. 1-6 may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor, comprising:
receiving a source string;
transliterating the source string using one or more discriminatively trained models into a target string; and
outputting the target string.

2. The method of claim 1 wherein the source string is received from a machine translator, and wherein the target string is combined with translated text from the machine translator into translated output text.

3. The method of claim 1 further comprising, training one or more discriminatively trained generative models, including transforming source-target pairs into derivations.

4. The method of claim 3 wherein transforming the source-target pairs into derivations comprises aligning one or more characters of a source string with one or more characters of a target string.

5. The method of claim 1 further comprising, training one or more discriminatively trained generative models via perceptron training.

6. The method of claim 1 wherein transliterating the source string comprises decoding by performing operations on source substrings, with each operation producing one or more target characters.

7. In a computing environment, a system, comprising, a transliteration engine that processes an input string in one language into an output string in another language, the transliteration engine including a decoder that uses one or more generative models, the models corresponding to weighted probabilities, with the weights learned as parameters via discriminative training based upon training data.

8. The system of claim 7 wherein the transliteration engine is coupled to a machine translator to transliterate strings that the machine translator does not translate, or wherein the transliteration engine is used in a spelling application, or wherein the transliteration engine is both coupled to a machine translator to transliterate strings that the machine translator does not translate and is used in a spelling application.

9. The system of claim 7 wherein the transliteration engine is used in computing edit distance between two strings.

10. The system of claim 7 further comprising, an aligner that transforms source-target pairs into derivations that are used for the discriminative training.

11. The system of claim 7, wherein the discriminative training is based upon perceptron training technology, maximum entropy training technology, or multiple additive regression tree training technology.

12. The system of claim 7 wherein the discriminative training uses features, comprising indicator features and hybrid generative model features.

13. The system of claim 7 wherein the features include one or more emission-related features, one or more transition-related features, or one or more lexicon features, or any combination of one or more emission-related features, one or more transition-related features, or one or more lexicon features.

14. The system of claim 7 wherein the discriminative training uses indicator features, including channel indicators, language model indicators or lexicon indicators, or any combination of channel indicators, language model indicators or lexicon indicators.

15. The system of claim 7 wherein the discriminative training uses generative features, including one or more channel models, one or more language models, or one or more dictionary models, or any combination of one or more channel models, one or more language models, or one or more dictionary models.

16. The system of claim 7 wherein the discriminative training uses lexicon indicators corresponding to frequencies of generated target words.

17. The system of claim 7 wherein the discriminative training uses a feature that indicates a new word being introduced, a target word frequency feature, a target character count feature, or an operation count feature, or any combination of a feature that indicates a new word being introduced, a target word frequency feature, a target character count feature, or an operation count feature.

18. One or more computer-readable media having computer-executable instructions, which when executed perform steps, comprising, discriminatively training generative models for to tune parameters for transliteration, including learning relative weights of probabilities for generative features extracted from training data corresponding to derivations, the generative features comprising hybrid generative models, the probabilities representing emission information, emission information and lexicon related information, and using the discriminatively training generative models in transliteration of a source string to a target string.

19. The one or more computer-readable media of claim 18 having further computer-executable instructions, comprising, extracting indicator features from the training data.

20. The one or more computer-readable media of claim 18 further comprising, transforming source-target pairs in the training data into the training data corresponding to the derivations.
